(19) United States
(12) Patent Application Publication
(10) Pub. No.: US 2024/0279369 A1
(43) Pub. Date: Aug. 22, 2024

(54) POLYVINYL ALCOHOL RESIN, POLYVINYL ACETAL RESIN, METHOD FOR PRODUCING POLYVINYL ALCOHOL RESIN, AND METHOD FOR PRODUCING POLYVINYL ACETAL RESIN

(71) Applicant: SEKISUI CHEMICAL CO., LTD., Osaka (JP)

(72) Inventors: Kenji YAMAUCHI, Shiga (JP); Tatsuya MATSUKUBO, Yamaguchi (JP); Takeshi WAKIYA, Osaka (JP); Jo OTSUKA, Yamaguchi (JP); Yumi KANEKO, Yamaguchi (JP); Kanako URADOKORO, Osaka (JP)

(73) Assignee: SEKISUI CHEMICAL CO., LTD., Osaka (JP)

(21) Appl. No.: 18/569,739

(22) PCT Filed: Jun. 20, 2022
(86) PCT No.: PCT/JP2022/024444

§ 371 Date: Dec. 13, 2023

(30) Foreign Application Priority Data
Jun. 24, 2021 (JP) 2021-104860

(51) Int. Cl. C08F 16/06; C08F 2/28; C08F 8/12; C08F 8/28; C08F 16/38; C08J 5/18

(52) U.S. Cl. CPC C08F 16/06; C08F 2/28; C08F 8/12; C08F 8/28; C08F 16/38; C08J 5/18; C08J 2429/14

(57) ABSTRACT

The present invention provides an ultra-high molecular weight polyvinyl alcohol resin that can provide, when acetalized, a resin film having high strength and high transparency. The present invention also provides a polyvinyl acetal resin, a method for producing a polyvinyl alcohol resin, and a method for producing a polyvinyl acetal resin. Provided is a polyvinyl alcohol resin having at least one selected from the group consisting of a sulfone group, an alkyl sulfonyl group, an aromatic sulfonyl group, a sulfine group, an imidazoline group, a carboxy group, an amide group, an amino group, and a hydroxy group at at least one molecular end of a main chain, having a weight average molecular weight (Mw) of 1,000,000 or more, and containing a water-soluble surfactant in an amount of 0.02% by weight or less.

### TECHNICAL FIELD

The present invention relates to a polyvinyl alcohol resin, a polyvinyl acetal resin, a method for producing a polyvinyl alcohol resin, and a method for producing a polyvinyl acetal resin.

### BACKGROUND ART

Polyvinyl alcohol resin (hereinafter referred to as PVA) obtainable by saponifying polyvinyl acetate resin (hereinafter referred to as PVAc) is colorless and transparent and has tough mechanical properties, and therefore is used in various applications. Polyvinyl acetal resin (hereinafter referred to as PVB) obtainable by acetalizing PVA is colorless and transparent and has higher mechanical strength than PVA, and therefore is used in applications such as interlayer films for a laminated glass for automobile windshields.

In order to further increase the toughness of PVA and PVB, it is necessary to increase the degree of polymerization of PVAc as a raw material. In production of PVA, normally, PVAc obtained by solution polymerization is used. However, it is difficult to control the amount of heat generated by solution polymerization, and the upper limit of the weight-average molecular weight of the resulting resin is about 700,000.

Concerning the average molecular weight of PVA, molecular weight characteristics determined using the intrinsic viscosity [η] (also called limiting viscosity) are often evaluated instead of the average molecular weight determined by, for example, GPC.

It is known that the Mark-Houwink equation gives a relation between the intrinsic viscosity [η] and the molecular weight M. In other words, the molecular weight is evaluated by [η]=kM^{a}. In the equation, k and a are constants determined by the type of polymer, the type of solvent, and the measurement temperature, and are independent of the degree of polymerization of the polymer. When the type of polymer, the type of solvent, and the measurement temperature are determined, the values of k and a can be known experimentally. The molecular weight obtained using the above equation is called the viscosity average molecular weight. The viscosity average molecular weight is the intermediate value between the values of the average molecular weight determined by the osmometry and the light scattering method, i.e., the intermediate value between the number average molecular weight and the weight average molecular weight. This is because the value of the constant a takes an intermediate value between 0.5 and 1.

Patent Literature 1 states that PVA with an ultra-high degree of polymerization can be obtained by using a solution containing a polyvinyl ester polymer emulsion having a particle size of 5 μm or less mixed with a predetermined amount of methanol.

Patent Literature 2 discloses a method for obtaining a polyvinyl alcohol resin with a high degree of polymerization. The method includes producing a polyvinyl ester polymer with a high degree of polymerization having a limiting viscosity of 2.3 dl/g or higher, with use of a specific solvent having a predetermined composition under predetermined polymerization temperature conditions, and saponifying the polyvinyl ester polymer to produce a polyvinyl alcohol resin with a high degree of polymerization.

Patent Literature 3 discloses a method for obtaining a polyvinyl alcohol resin with a high degree of polymerization. The method includes photoemulsion-polymerizing a vinyl ester monomer at a low polymerization temperature of −60° C. or higher and 10° C. or lower to produce a polyvinyl ester with a high degree of polymerization having a limiting viscosity of 1.5 dl/g or higher, and saponifying the polyvinyl ester to produce a polyvinyl alcohol resin with a high degree of polymerization.

### CITATION LIST

### Patent Literature

Patent Literature 1: JP 1945837 B
Patent Literature 2: JP 2534294 B
Patent Literature 3: JP 2599716 B

### SUMMARY OF INVENTION

### Technical Problem

These methods can provide a polyvinyl alcohol resin with a high degree of polymerization. However, since reaction is carried out at an extremely low temperature, addition of a large amount of dispersant is needed for micelle formation in emulsion polymerization. Such a dispersant serves as a foreign substance in production of a polyvinyl acetal resin, causing cloudiness of the resulting resin film.

The present invention aims to provide an ultra-high molecular weight polyvinyl alcohol resin that can provide, when acetalized, a resin film having high strength and high transparency. The present invention aims to provide a polyvinyl acetal resin, a method for producing a polyvinyl alcohol resin, and a method for producing a polyvinyl acetal resin.

### Solution to Problem

The present disclosure (1) is a polyvinyl alcohol resin having at least one selected from the group consisting of a sulfone group, an alkyl sulfonyl group, an aromatic sulfonyl group, a sulfine group, an imidazoline group, a carboxy group, an amide group, an amino group, and a hydroxy group at at least one molecular end of a main chain, having a weight average molecular weight (Mw) of 1,000,000 or more, and containing a water-soluble surfactant in an amount of 0.02% by weight or less.

The present disclosure (2) is the polyvinyl alcohol resin according to the present disclosure (1) containing 0.0000001% by weight or more of a cationic surfactant.

The present disclosure (3) is the polyvinyl alcohol resin according to the present disclosure (1) or (2), wherein a ratio (Mw/Mn) of the weight average molecular weight (Mw) to a number average molecular weight (Mn) is 1.0 to 3.0.

The present disclosure (4) is the polyvinyl alcohol resin in any combination with any of the present disclosures (1) to (3), wherein the polyvinyl alcohol resin has a degree of saponification of 70 mol % or higher and 99 mol % or lower.

The present disclosure (5) is the polyvinyl alcohol resin in any combination with any of the present disclosures (1) to (4), wherein the polyvinyl alcohol resin has a cloud point of 30° C. or higher.

The present disclosure (6) is the polyvinyl alcohol resin in any combination with any of the present disclosures (1) to (5), wherein the polyvinyl alcohol resin contains at least one selected from the group consisting of a dialkylamine compound containing a C1-C10 alkyl group and a trialkylamine compound containing a C1-C10 alkyl group.

The present disclosure (7) is a polyvinyl acetal resin which is an acetalized product of the polyvinyl alcohol resin according to any one of the present disclosures (1) to (6).

The present disclosure (8) is an interlayer film for a laminated glass, containing the polyvinyl acetal resin according to the present disclosure (7).

The present disclosure (9) is a binder composition containing the polyvinyl acetal resin according to the present disclosure (7).

The present disclosure (10) is a method for producing a polyvinyl alcohol resin, including: a polymerization step of polymerizing a vinyl ester with addition of a polymerization initiator to produce a polyvinyl ester; and a saponification step of saponifying the polyvinyl ester with addition of a saponification catalyst to produce a 20 water-soluble polyvinyl alcohol resin, wherein the polymerization initiator contains at least one selected from the group consisting of a sulfone group, an alkyl sulfonyl group, an aromatic sulfonyl group, a sulfine group, an imidazoline group, a carboxy group, an amide 25 group, an amino group, and a hydroxy group.

The present disclosure (11) is the method for producing a polyvinyl alcohol resin according to the present disclosure (10), wherein a water-soluble surfactant is added in the polymerization step in an amount of 0.02 parts by weight or less per 100 parts by weight of the vinyl ester.

The present disclosure (12) is the method for producing a polyvinyl alcohol resin according to the present disclosure (10) or (11), wherein the polymerization step involves adding a polymerization initiator to an aqueous monomer solution containing a vinyl ester and water to produce an aqueous emulsion polymerization slurry containing a polyvinyl ester, where the polyvinyl ester in the aqueous emulsion polymerization slurry has an average particle size of 0.01 μm or more and 10 μm or less; and the saponification step involves directly adding a saponification catalyst to the aqueous emulsion polymerization slurry to saponify the polyvinyl ester, where the saponification catalyst is at least one selected from the group consisting of a dialkylamine compound containing a C1-C10 alkyl group and a trialkylamine compound containing a C1-C10 alkyl group.

The present disclosure (13) is the method for producing a polyvinyl alcohol resin according to the present disclosure (10) or (11), wherein the polymerization step involves adding a polymerization initiator to an aqueous monomer solution containing a vinyl ester and water to produce an aqueous emulsion polymerization slurry containing a polyvinyl ester and further includes a recovery step of filtering a slurry prepared by adding a cationic surfactant to the aqueous emulsion polymerization slurry to recover the polyvinyl ester, and the saponification step involves saponifying the polyvinyl ester recovered in the recovery step.

The present disclosure (14) is the method for producing a polyvinyl alcohol resin according to any one of the present disclosures (10) to (13), wherein a ratio (Mw/Mn) of a weight average molecular weight (Mw) to a number average molecular weight (Mn) of the polyvinyl ester is 1.0 to 3.0.

The present disclosure (15) is a method for producing a polyvinyl acetal resin, including acetalizing the polyvinyl alcohol resin obtained by the method for producing a polyvinyl alcohol resin according to any one of the present disclosures (10) to (14) with addition of an aldehyde.

The present invention will be described in detail below.

As a result of intensive studies, the present inventors have found that an ultra-high molecular weight polyvinyl alcohol resin having a specific substituent at a molecular end and containing a water-soluble surfactant in a predetermined amount relative to the weight of the entire resin can provide, when acetalized, a molded article having excellent strength and a resin film having excellent transparency. Thus, the present invention was completed.

The polyvinyl alcohol resin of the present invention has at least one selected from the group consisting of a sulfone group, an alkyl sulfonyl group, an aromatic sulfonyl group, a sulfine group, an imidazoline group, a carboxy group, an amide group, an amino group, and a hydroxy group at at least one molecular end of the main chain.

The polyvinyl alcohol resin containing the substituent has a tough mechanical strength, and is acetalized into a polyvinyl acetal resin capable of providing, when molded, a molded article having high strength and excellent transparency.

The polyvinyl alcohol resin has the functional group at at least one molecular end of the main chain. One having a carboxy group may have, in addition to the carboxy group, a carboxyalkylamino group such as a carboxyethylamino group or a carboxyalkylamidine group such as a carboxyethylamidine group at a molecular end.

One having a hydroxy group may have, in addition to the hydroxy group, a hydroxyalkylamino group such as a hydroxyethylamino group or a hydroxyalkylamide group such as a hydroxyethylamide group at a molecular end.

The sulfone group may be a salt or an ester. Examples of the salt include ammonium salt, sodium salt, and potassium salt. Examples of the ester include esters containing C1-C12 aliphatic groups or C6-C12 aromatic groups. More preferred are alkyl esters.

Examples of the alkyl sulfonyl group include sulfonyl groups containing a C1-C12 alkyl group. Specific examples thereof include a methyl sulfonyl group, an ethyl sulfonyl group, and a propyl sulfonyl group.

Examples of the aromatic sulfonyl group include sulfonyl groups containing aromatic groups having a carbon number of 12 or less. Specific examples thereof include a phenylsulfonyl group.

The sulfine group may be a salt or an ester. Examples of the salt include ammonium salt, sodium salt, and potassium salt. Examples of the ester include esters containing C1-C12 aliphatic groups or C6-C12 aromatic groups. More preferred are alkyl esters.

The amino group may be a C1-C10 (preferably C1-C5, more preferably C1-C3) monoamino, diamino, or triamino group.

Among these, the polyvinyl alcohol resin preferably has a sulfone group at a molecular end.

In a suitable embodiment of the present invention, the specific substituent at at least one molecular end of the main chain of the polyvinyl alcohol resin is preferably derived from a polymerization initiator.

The polyvinyl alcohol resin of the present invention has a weight average molecular weight (Mw) of 1,000,000 or more.

When the weight average molecular weight is 1,000,000 or more, the toughness of the resin can be enhanced. A polyvinyl acetal resin obtained by acetalizing such a polyvinyl alcohol resin can provide, when molded, a molded article having high strength.

The polyvinyl alcohol resin of the present invention preferably has a weight average molecular weight (Mw) of 1,500,000 or more, more preferably 2,000,000 or more, and preferably 4,000,000 or less, more preferably 3,000,000 or less.

The polyvinyl alcohol resin of the present invention preferably has a number average molecular weight (Mn) of 500,000 or more, more preferably 1,000, 000 or more, and preferably 2,000,000 or less, more preferably 1,500,000 or less.

The ratio (Mw/Mn) of the weight average molecular weight (Mw) to the number average molecular weight (Mn) of the polyvinyl alcohol resin of the present invention is preferably 1.0 or more, more preferably 1.5 or more, and preferably 3.0 or less, more preferably 2.0 or less.

When the ratio is set within the above range, the toughness of the resin can be further improved.

The weight average molecular weight (Mw) and the number average molecular weight (Mn) can be determined by, for example, measurement on the polyvinyl alcohol resin by gel permeation chromatography (GPC), measurement on the polyvinyl ester before saponification by GPC, measurement on a polyvinyl ester obtained by re-esterification of the polyvinyl alcohol resin by GPC, or measurement of the viscosity of an aqueous solution of the polyvinyl alcohol resin in conformity with JIS K6726. In the measurement, for example, polystyrene is used as a standard and columns such as TSKgel (Tosoh Corporation), PLgel (AMR Inc.), KF-806, and KF-807 (Shodex) can be used.

The degree of saponification of the polyvinyl alcohol resin of the present invention is preferably 70 mol % or higher and preferably 99.9 mol % or lower.

When the degree of saponification is set within the above range, the toughness of the resin can be further enhanced. When the polyvinyl alcohol resin is made into a polyvinyl alcohol resin film, both water resistance and gas barrier properties can be enhanced in a well-balanced manner.

The degree of saponification is more preferably 80 mol % or higher, still more preferably 85 mol % or higher, even more preferably 90 mol % or higher, particularly preferably 92 mol % or higher, more particularly preferably 93 mol % or higher, most preferably 94 mol % or higher. The degree of saponification is preferably 99 mol % or lower, more preferably 98.5 mol % or lower, still more preferably 98 mol % or lower, particularly preferably 97 mol % or lower, most preferably 95 mol % or lower.

The degree of saponification can be measured in conformity with JIS K6726. The degree of saponification indicates the proportion of units actually converted to vinyl alcohol units among units that can be converted to vinyl alcohol units by saponification.

The degree of saponification can be appropriately adjusted by saponification conditions, that is, hydrolysis conditions.

The polyvinyl alcohol resin of the present invention preferably has a cloud point of 30° C. or higher.

When the cloud point is set within the above range, the toughness of the resin can be further improved.

The cloud point is more preferably 35° C. or higher, still more preferably 40° C. or higher, and may be, for example, 90° C. or lower.

The cloud point can be visually confirmed, and can also be measured, for example, using a haze meter or by a static light scattering method.

When the polyvinyl alcohol resin of the present invention is dissolved in water at a concentration of 4% by weight, the proportion of undissolved components is preferably 10% by weight or less, more preferably 18 by weight or less. The lower limit thereof is not limited, and is preferably 0% by weight.

The proportion of the undissolved components can be measured by mesh filtration, for example, as follows. A resin aqueous solution at a concentration of 4% by weight is allowed to stand still for 12 hours or longer, and the temperature thereof is raised to 80° C. The solution is again allowed to stand still to be cooled to room temperature. Using a metal mesh (#100 mesh), water and water-absorbed and swollen resin are separated. The separated resin is dried at 60° C. for three hours, and the weight of the resin including the metal mesh after drying is measured. The proportion of undissolved components is calculated using the following formula.

$$Proportion of undissolved components ( \% by weight ) = 100 \times ( W 1 - W 2 ) / W 0$$

(W0: initial weight of resin, W1: weight of resin including metal mesh after drying, W2: initial weight of metal mesh)

The degree of polymerization of the polyvinyl alcohol resin of the present invention is preferably 10,000 or more, and preferably 30,000 or less. The degree of polymerization of the polyvinyl alcohol resin can be measured, for example, by measurement on the polyvinyl acetate resin before saponification by gel permeation chromatography (GPC) or measurement of the viscosity of an aqueous solution of the polyvinyl alcohol resin in conformity with JIS K6726.

The polyvinyl alcohol resin of the present invention contains a water-soluble surfactant in an amount of 0.02% by weight or less.

In other words, when the polyvinyl alcohol resin of the present invention contains a water-soluble surfactant and other components, the polyvinyl alcohol resin of the present invention can be regarded as a polyvinyl alcohol resin composition containing the polyvinyl alcohol resin, and the amount of the water-soluble surfactant in the entire amount of the composition is 0.02% by weight or less.

When the amount of the water-soluble surfactant is within the above range, the resin can have high transparency.

The amount of the water-soluble surfactant is preferably 0.002% by weight or less. The lower limit thereof is not limited, and is preferably 0% by weight, more preferably 0.0005% by weight or more.

The method for measuring the amount of the water-soluble surfactant is not limited. It can be measured, for example, by a method using liquid chromatography such as HPLC or by an extraction method using methanol.

The water-soluble surfactant is preferably a surfactant having a solubility in water at 25° C. of 10 g/100 g or more.

The water-soluble surfactant is used as a dispersant added during emulsion polymerization. Examples thereof include anionic surfactants such as alkylsulfonates and polymeric surfactants such as polyalkylene glycol.

Examples of the alkylsulfonates include sodium salts, potassium salts, and ammonium salts of octylsulfonic acid, decylsulfonic acid, dodecylsulfonic acid, and p-toluenesulfonic acid.

When the polyvinyl alcohol resin of the present invention is made into a resin solution, the resin solution becomes cloudy even when the amount of the water-soluble surfactant is very small. In addition, since the polyvinyl alcohol resin of the present invention has a very high molecular weight, the resin solution becomes cloudy also when the solubility in a solvent is poor. In the present invention, the water-soluble surfactant is usually an anionic surfactant.

The polyvinyl alcohol resin of the present invention may contain a cationic surfactant.

The polyvinyl alcohol resin containing the cationic surfactant can have higher transparency.

The cationic surfactant is different from the water-soluble surfactant, and preferably has a solubility in water at 25° C. of 0.05 g/100 g or more.

Examples of the cationic surfactant include quaternary ammonium salts, amine salts such as aliphatic amine salts, aromatic amine salts, and heterocyclic amine salts, and phosphonium salts.

Examples of the quaternary ammonium salts include tetraethylammonium chloride, tetraethylammonium bromide, tetrabutylammonium bromide, tetrabutylammonium chloride, hexyltrimethylammonium bromide, n-octyltrimethylammonium bromide, n-octyltrimethylammonium chloride, nonyltrimethylammonium bromide, decyltrimethylammonium chloride, decyltrimethylammonium bromide, dodecyltrimethylammonium chloride, dodecyltrimethylammonium bromide, tetradecyltrimethylammonium bromide, tetradecyltrimethylammonium chloride, hexadecyltrimethylammonium chloride, hexadecyltrimethylammonium bromide, hexadecyltrimethylammonium hexafluorophosphate, hexadecyltrimethylammonium tetrafluoroborate, hexadecyltrimethylammonium perchlorate, hexadecyltrimethylammonium hydroxide, hexadecyltrimethylammonium hydrogen sulfate, heptadecyltrimethylammonium bromide, octadecyltrimethylammonium chloride, octadecyltrimethylammonium bromide, benzyldodecyldimethylammonium chloride, benzyldodecyldimethylammonium bromide, benzyldimethyltetradecylammonium chloride, benzylhexadecyldimethylammonium chloride, benzyldimethyloctadecylammonium chloride, benzalkonium chloride, benzethonium chloride, dodecan-1-yl(ethyl)(dimethyl)ammonium ethyl sulfate, distearyldimethylammonium chloride, docosyltrimethylammonium chloride, 1-dodecylpyridinium chloride, hexadecylpyridinium chloride, hexadecylpyridinium bromide, 1-hexadecyl-4-methylpyridinium chloride, 1-ethyl-3-methylimidazolium chloride, cetylpyridinium chloride, and benzethonium chloride.

Examples of the amine salts include stearic acid dimethylaminopropylamide, n-octylammonium chloride, n-octylammonium bromide, dodecylamine hydrochloride, dodecyl ammonium bromide, and octadecylamine hydrochloride.

Examples of the phosphonium salts include trans-2-butene-1,4-bis(triphenylphosphonium chloride), tributyl(cyanomethyl)phosphonium chloride, (2-carboxyethyl)triphenylphosphonium bromide, tributyldodecylphosphonium bromide, tributylhexadecylphosphonium bromide, tributyl-n-octylphosphonium bromide, tetrakis(hydroxymethyl)phosphonium chloride, tetraphenylphosphonium bromide, tetrakis(hydroxymethyl)phosphonium sulfate, tetrabutylphosphonium bromide, tetraphenylphosphonium chloride, tetraethylphosphonium bromide, tetrabutylphosphonium chloride, tetra-n-octylphosphonium bromide, tetraethylphosphonium hexafluorophosphate, tetraethylphosphonium tetrafluoroborate, tetrabutylphosphonium tetrafluoroborate, tetrabutylphosphonium hexafluorophosphate, tetrabutylphosphonium tetraphenylborate, and tributylhexylphosphonium bromide.

Among these, preferred are quaternary ammonium salts, amine salts, and phosphonium salts, and more preferred are quaternary ammonium salts and amine salts. Still more preferred are 1-ethyl-3-methylimidazolium chloride, cetylpyridinium chloride, tetrabutylammonium bromide, tetrabutylammonium chloride, hexyltrimethylammonium bromide, n-octyltrimethylammonium bromide, n-octyltrimethylammonium chloride, nonyltrimethylammonium bromide, decyltrimethylammonium chloride, decyltrimethylammonium bromide, dodecyltrimethylammonium chloride, dodecyltrimethylammonium bromide, tetradecyltrimethylammonium bromide, tetradecyltrimethylammonium chloride, hexadecyltrimethylammonium chloride, octadecyltrimethylammonium chloride, benzyldodecyldimethylammonium chloride, dodecan-1-yl(ethyl)(dimethyl)ammonium ethyl sulfate, hexadecyltrimethylammonium bromide, tetraethylammonium bromide, benzethonium chloride, and stearic acid dimethylaminopropylamide. Even more preferred are tetrabutylammonium bromide and stearic acid dimethylaminopropylamide.

When the polyvinyl alcohol resin contains a cationic surfactant, the amount of the cationic surfactant in the polyvinyl alcohol resin of the present invention is preferably 0% by weight or more.

The polyvinyl alcohol resin containing a cationic surfactant in an amount within the above range can have higher transparency.

When the polyvinyl alcohol resin contains a cationic surfactant, the amount of the cationic surfactant is more preferably greater than 0% by weight, still more preferably 0.0000001% by weight or more, particularly preferably 0.0001% by weight or more, and preferably 0.002% by weight or less, more preferably 0.0015% by weight or less, still more preferably 0.0018 by weight or less.

The amount of the cationic surfactant can be measured by the HPLC method or the GC-MS method.

The polyvinyl alcohol resin of the present invention may contain at least one selected from the group consisting of a dialkylamine compound containing a C1-C10 alkyl group and a trialkylamine compound containing a C1-C10 alkyl group.

The polyvinyl alcohol resin containing any of the compounds can have higher toughness.

Preferred among these are a dialkylamine containing a C1-C10 alkyl group and a C1-C10 trialkylamine.

Examples of the dialkylamine compound containing a C1-C10 alkyl group include dimethylamine and diethylamine.

Examples of the trialkylamine containing a C1-C10 alkyl group include trimethylamine, triethylamine, and tributylamine.

The total amount of the dialkylamine compound and the trialkylamine compound in the polyvinyl alcohol resin of the present invention is preferably 0.00001% by weight or more, more preferably 0.0001% by weight or more, and preferably 0.1% by weight or less, more preferably 0.05% by weight or less.

The amount can be measured by the HPLC method or the GC-MS method.

A method for producing the polyvinyl alcohol resin of the present invention is preferably a method including a polymerization step of polymerizing a vinyl ester with addition of a polymerization initiator containing a specific substituent to produce a polyvinyl ester, and a saponification step of saponifying the polyvinyl ester with addition of a saponification catalyst.

The present invention also encompasses a method for producing a polyvinyl alcohol resin, including: a polymerization step of polymerizing a vinyl ester with addition of a polymerization initiator to produce a polyvinyl ester; and a saponification step of saponifying the polyvinyl ester with addition of a saponification catalyst to produce a water-soluble polyvinyl alcohol resin, wherein the polymerization initiator contains at least one selected from the group consisting of a sulfone group, an alkyl sulfonyl group, an aromatic sulfonyl group, a sulfine group, an imidazoline group, a carboxy group, an amide group, and a hydroxy group.

The polymerization step involves adding a polymerization initiator to an aqueous monomer solution containing a vinyl ester and water to produce an aqueous emulsion polymerization slurry containing a polyvinyl ester.

Any vinyl ester may be used. Examples include vinyl formate, vinyl acetate, vinyl propionate, and vinyl pivalate. Preferred among these is vinyl acetate.

The polyvinyl ester may be obtained through copolymerization with a vinyl monomer as long as the degree of polymerization and degree of saponification of the resulting polyvinyl alcohol resin are not affected.

Examples of the vinyl monomer include ethylene, butadiene, 1,3-butadiene, propylene, 1-butene, 1-hexene, 4-methyl-1-pentene, isoprene, acrylic acid esters, methacrylic acid esters, higher fatty acid vinyl esters of maleic acid, fumaric acid, itaconic acid, and the like, alkyl vinyl ethers, N-(2-dimethylaminoethyl) methacrylamides or quaternized products thereof, N-vinylimidazole or quaternized products thereof, N-vinylpyrrolidone, N-n-butoxymethylacrylamide, vinyltrimethoxysilane, vinylmethyldimethoxysilane, vinyldimethylmethoxysilane, acrylonitrile, methacrylamide derivatives, acrylamide derivatives, vinylidene fluoride, α-methylstyrene, N-alkyl-substituted maleimide, acenaphthylene, and vinylene carbonate.

The polyvinyl ester preferably has a weight average molecular weight of 1,000,000 or more.

Normally, increasing the degree of polymerization to about 1,000,000 is very difficult. Since the polymerized resin has a high Tg, the molecular ends have poor mobility, and therefore have a very low probability of collision with radicals. It is therefore usually difficult to obtain a high-molecular-weight polyvinyl ester having a weight average molecular weight of 1,000,000 or more.

Normally, in emulsion polymerization, monomer polymerization proceeds in dispersant micelles. In order to obtain a high-molecular-weight resin, huge micelles need to be formed, which requires a large amount of dispersant. In such a case, the resulting resin contains a large amount of dispersant as a foreign substance, and therefore has poor transparency and poor strength. In the polymerization step for producing the polyvinyl ester, the dispersant used in normal emulsion polymerization is not used. A vinyl ester monomer dispersed in water is polymerized starting from the water-soluble radical polymerization initiator containing a sulfone group, a sulfonyl group, a sulfine group, an imidazoline group, a carboxy group, an amide group, or a hydroxy group. In the polymerization, the water-soluble radical polymerization initiator is used at low concentration for dispersion in order to avoid collision or agglomeration of the monomer domains.

Such a reaction can provide a polymer having a uniform domain size and a uniform particle size.

The polymerization step allows uniform growth of molecules in the particles, enabling synthesis of a resin having a very high molecular weight such as a weight average molecular weight of 4,000,000 or more. The reason why the weight average molecular weight increases is that polymerization using a water-soluble radical polymerization initiator containing a sulfone group, a sulfonyl group, a sulfine group, an imidazoline group, a carboxy group, an amide group, or a hydroxy group at a low concentration can minimize disproportionation reaction such as hydrogen abstraction and multiple polymers are less likely to grow in the domain.

The polymerization initiator used may be a water-soluble radical polymerization initiator containing at least one selected from the group consisting of a sulfone group, a sulfonyl group, a sulfine group, an imidazoline group, a carboxy group, an amide group, and a hydroxy group.

In the polymerization using the polymerization initiator, since the water-soluble radical polymerization initiator is used, a high-molecular-weight polyvinyl ester can be produced without adding a large amount of dispersant as in normal emulsion polymerization.

Examples of the water-soluble radical polymerization initiator include acid mixtures of imidazole azo compounds such as 2,2′-azobis [2-(2-imidazolin-2-yl) propane] dihydrochloride, 2,2′-azobis [2-(2-imidazolin-2-yl) propane]sulfatohydrate, and 2,2′-azobis [2-(2-imidazolin-2-yl) propane]; water-soluble azo compounds such as 2,2′-azobis(2-methylpropionamidine) dihydrochloride, 2,2′-azobis [N-(2-carboxyethyl)-2-methylpropionamidine]tetrahydrate, 2,2′-azobis [2-methyl-N-(2-hydroxyethyl) propionamide], and 4,4′-azobis-4-cyanovaleric acid; oxoacids such as potassium persulfate (potassium peroxodisulfate), ammonium persulfate (ammonium peroxodisulfate), and sodium persulfate (sodium peroxodisulfate); and peroxides such as hydrogen peroxide, peracetic acid, performic acid, and perpropionic acid.

Preferred among these are acid mixtures of imidazole azo compounds, water-soluble azo compounds, and oxoacids. More preferred are 2,2′-azobis [2-(2-imidazolin-2-yl) propane]dihydrochloride, 2,2′-azobis(2-methylpropionamidine) dihydrochloride, 2,2′-azobis [N-(2-carboxyethyl)-2-methylpropionamidine]tetrahydrate, 2,2′-azobis [2-methyl-N-(2-hydroxyethyl) propionamide], potassium persulfate, ammonium persulfate, and sodium persulfate. In order to reduce residues, still more preferred are potassium persulfate and ammonium persulfate.

According to the above method, a polyvinyl ester having a weight average molecular weight within a predetermined range can be produced. The weight average molecular weight of the polyvinyl ester may be adjusted by adding a chain transfer agent or a polymerization terminator.

Any chain transfer agent or any polymerization terminator may be used. Examples thereof include sodium 3-mercapto-1-propanesulfonate, mercaptosuccinic acid, mercaptopropanediol, (allylsulfonyl)benzene, ethyl 2-mercaptoethanesulfinate, and 3-mercaptopropionamide.

By adding the chain transfer agent or the polymerization terminator, a polyvinyl ester having at least one selected from the group consisting of a sulfone group, a sulfonyl group, a sulfine group, an imidazoline group, a carboxy group, an amide group, and a hydroxy group at at least one molecular end of the main chain and having a weight average molecular weight within a predetermined range can be produced.

These water-soluble radical polymerization initiators may be used alone, or two or more thereof may be used in combination.

The amount of the water-soluble radical polymerization initiator added is preferably 0.03 to 0.2 parts by weight, more preferably 0.05 to 0.15 parts by weight, relative to 100 parts by weight of the raw material monomer.

When the amount is 0.03 parts by weight or more, the rate of reaction of the raw material monomer can be sufficiently increased. When the amount is 0.2 parts by weight or less, the molecular weight of the polyvinyl ester can be sufficiently increased.

When the amount is within the above range, the polyvinyl ester having at least one selected from a sulfone group, a sulfonyl group, a sulfine group, an imidazoline group, a carboxy group, an amide group, and a hydroxy group at the molecular end (ω-position) is dispersed in water at low concentration to enable production of a resin with a uniform particle size.

In emulsion polymerization, normally, a water-soluble surfactant is added in an amount of 1 part by weight or more per 100 parts by weight of the raw material monomer. The amount is preferably smaller because a water-soluble surfactant serves as a foreign substance in formation of a resin sheet. However, simple reduction of the amount of a water-soluble surfactant is insufficient to enable polymerization of a high-molecular-weight resin. When the amount of the water-soluble radical polymerization initiator is within the above range, polymerization domains remain dispersed in water with no or little addition of an emulsifier, enabling production of a polyvinyl ester having a very high molecular weight.

The amount of the raw material monomer added is preferably 50 to 300 parts by weight per 1,000 parts by weight of water.

When the amount is within the above range, aggregation during polymerization or adhesion of resin to the reaction vessel can be prevented.

The amount of the raw material monomers added is more preferably 70 to 200 parts by weight per 1,000 parts by weight of water.

When the amount is within the above range, residual monomers can be reduced to achieve uniform polymerization.

For dispersing the vinyl ester monomer in water, a device such as a high-speed rotating mixer is not required. The monomer charged can be dispersed by rotation of a blade at 100 to 250 rpm.

The reaction temperature in the polymerization step is preferably 50° C. or higher and preferably 70° C. or lower.

Since heat of reaction of vinyl acetate, a vinyl ester monomer, is high, reaction at a very high temperature is nor preferred. When the reaction temperature is 50° C. or higher, radicals can be sufficiently generated, allowing sufficient proceeding of the reaction. When the reaction temperature is 70° C. or lower, scale adhesion to the reaction vessel can be suppressed, preventing defective polymerization.

In the polymerization step, a small amount of water-soluble surfactant may be added.

The water-soluble surfactant is used as a dispersant to be added during emulsion polymerization. Examples thereof include those mentioned above.

The amount of the water-soluble surfactant added is preferably 0 to 0.02 parts by weight, more preferably 0.002 to 0.01 parts by weight, per 100 parts by weight of the raw material monomer.

In the polymerization step, a polymerization initiator is added to an aqueous monomer solution containing a vinyl ester and water to produce an aqueous emulsion polymerization slurry containing a polyvinyl ester. The polymerization step preferably further includes a recovery step of filtering a slurry prepared by adding a cationic surfactant to the aqueous emulsion polymerization slurry to recover the polyvinyl ester.

Examples of the cationic surfactant include those mentioned above.

The amount of the cationic surfactant added is preferably 1×10⁻⁶ to 10,000×10⁻⁶ parts by weight per 100 parts by weight of the raw material monomer.

When the amount is within the above range, the cationic surfactant can be fully adsorbed to the resulting polyvinyl ester, which improves the re-solubility of the resulting resin.

The average particle size of the polyvinyl ester in the aqueous emulsion polymerization slurry is preferably 0.001 μm or larger and preferably 50 μm or smaller.

When the amount is within the above range, the resulting resin can have higher transparency.

The average particle size is more preferably 0.005 μm or larger, still more preferably 0.01 μm or larger, even more preferably 0.1 μm or larger, and more preferably 30 μm or smaller, still more preferably 10 μm or smaller, even more preferably 5 μm or smaller, particularly preferably 1 μm or smaller, more particularly preferably 0.8 μm or smaller, most preferably 0.5 μm or smaller.

The ratio (Mw/Mn) of the weight average molecular weight (Mw) to the number average molecular weight (Mn) of the polyvinyl ester is preferably 1.0 or more and preferably 3.0 or less.

When the ratio is within the above range, the resulting resin can have higher transparency.

The ratio is more preferably 1.5 or more, and more preferably 2.0 or less.

The saponification step may be carried out by, for example, a method of directly adding a saponification catalyst to the aqueous emulsion polymerization slurry obtained in the polymerization step, or a method of saponifying the polyvinyl ester recovered in the recovery step.

Examples of the saponification catalyst include alkali catalysts such as sodium hydroxide, potassium hydroxide, sodium alcoholate, and sodium carbonate, and acid catalysts such as sulfuric acid, phosphoric acid, and hydrochloric acid. In order to increase the saponification speed and improve the productivity, alkali catalysts are preferred, and sodium hydroxide is particularly preferred.

In the method of directly adding a saponification catalyst to the aqueous emulsion polymerization slurry, the saponification catalyst used is preferably an amine such as a dialkylamine compound or a trialkylamine compound.

Examples of the dialkylamine compound include a dialkylamine compound containing a C1-C10 alkyl group. Examples of the trialkylamine compound include a trialkylamine compound containing a C1-C10 alkyl group. Specific examples include dimethylamine, diethylamine, trimethylamine, triethylamine, and tributylamine.

In the method of saponifying the polyvinyl ester recovered in the recovery step, preferably, the polyvinyl ester is added to an organic solvent, followed by addition of a saponification catalyst.

Examples of the saponification catalyst in this method include alkali catalysts such as sodium hydroxide, potassium hydroxide, sodium alcoholate, and sodium carbonate, and acid catalysts such as sulfuric acid, phosphoric acid, and hydrochloric acid. In order to increase the saponification speed and improve the productivity, alkali catalysts are preferred, and sodium hydroxide is particularly preferred.

The amount of the saponification catalyst used is preferably 0.002 to 0.50, more preferably 0.003 to 0.30, particularly preferably 0.004 to 0.10 in terms of the molar ratio to the vinyl ester monomer unit of a vinyl ester copolymer. The saponification catalyst may be added all at once at the beginning of the saponification reaction, or may be partly added at the beginning of the saponification reaction and the rest may be added afterwards during the saponification reaction.

The saponification reaction is preferably carried out at a temperature of 5° C. to 80° C., more preferably 20° C. to 70° C. The saponification reaction is preferably carried out for 5 minutes to 10 hours, more preferably 10 minutes to 5 hours. The saponification reaction can be carried out by either a batch method or a continuous method. After completion of the saponification reaction, the remaining catalyst may be neutralized, if needed. Examples of usable neutralizing agents include organic acids such as acetic acid and lactic acid, and ester compounds such as methyl acetate.

After saponification and neutralization, a step of washing the PVA resin may be provided, if needed. The washing liquid used may be a solution containing a lower alcohol such as methanol as a main component and further containing water and/or an ester such as methyl acetate produced in the saponification step.

Examples of the organic solvent include alcohols such as methanol, ethanol, propanol, butanol, tertiary butanol, isobutanol, isopropyl alcohol, n-propyl alcohol, hexanol, 2-ethylhexanol, benzyl alcohol, ethylene glycol, propylene glycol, glycerol, and diethylene glycol; esters such as methyl acetate, ethyl acetate, butyl acetate, amyl acetate, methyl lactate, and ethyl lactate; hydrocarbons such as toluene, xylene, cyclohexane, isooctane, and isopentane; ketones such as acetone, methyl ethyl ketone, methyl propyl ketone, methyl isobutyl ketone, cyclohexanone, and diacetone alcohol; ethers such as methyl cellosolve, ethyl cellosolve, butyl cellosolve, and 1,4-dioxane; and tetrahydrofuran, 2-pyrrolidone, NMP, and DMF.

The present invention also encompasses the method for producing a polyvinyl alcohol resin, wherein the polymerization step involves adding a polymerization initiator to an aqueous monomer solution containing a vinyl ester and water to produce an aqueous emulsion polymerization slurry containing a polyvinyl ester, where the polyvinyl ester in the aqueous emulsion polymerization slurry has an average particle size of 0.01 μm or more and 0.5 μm or less; and the saponification step involves directly adding a saponification catalyst to the aqueous emulsion polymerization slurry to saponify the polyvinyl ester, where the saponification catalyst is at least one selected from the group consisting of a dialkylamine compound containing a C1-C10 alkyl group and a trialkylamine compound containing a C1-C10 alkyl group.

The present invention also encompasses the method for producing a polyvinyl alcohol resin, wherein the polymerization step involves adding a polymerization initiator to an aqueous monomer solution containing a vinyl ester and water to produce an aqueous emulsion polymerization slurry containing a polyvinyl ester and further includes a recovery step of filtering a slurry prepared by adding a cationic surfactant to the aqueous emulsion polymerization slurry to recover the polyvinyl ester, and the saponification step involves saponifying the polyvinyl ester recovered in the recovery step.

The polyvinyl alcohol resin has an ultra-high molecular weight and therefore can be preferably used for applications such as film applications.

When a packaging film or a film to be stretched is produced using the polyvinyl alcohol resin, gas barrier properties can be effectively improved, and a uniform film can be obtained.

The film contains the polyvinyl alcohol resin.

The film may optionally contain additives such as a surface tension modifier, an antifoaming agent, a surfactant, a preservative, and a water-soluble plasticizer such as glycerol or polyethylene glycol.

The film may be provided as a laminated film including the film laminated on a support member.

The material of the support member is not limited. Examples thereof include a polyolefin resin, a polyester resin, and an acrylic resin. Examples of the polyolefin resin include polyethylene, polypropylene, an ethylene-vinyl acetate copolymer, and an ethylene-vinyl alcohol copolymer. Examples of the polyester resin include polyethylene terephthalate and polyethylene naphthalate. The material of the support member is preferably not a polyvinyl alcohol resin.

The film may have a dichroic pigment adsorbed on its surface. The film having the above structure can be suitably used as a polarizing layer of a polarizer.

Examples of the dichroic pigment include iodine and dichroic dyes such as azo dyes, anthraquinone dyes, and tetrazine dyes. Azo dyes are preferred from the standpoint of the optical properties and durability of the polarizer.

Examples of the azo dyes include C.I. Direct Yellow 12, C.I. Direct Yellow 28, C.I. Direct Yellow 44, C.I. Direct Yellow 142, C.I. Direct Orange 26, C.I. Direct Orange 39, C.I. Direct Orange 71, C.I. Direct Orange 107, C.I. Direct Red 2, C.I. Direct Red 31, C.I. Direct Red 79, C.I. Direct Red 81, C.I. Direct Red 117, C.I. Direct Red 247, C.I. Direct Green 80, C.I. Direct Green 59, C.I. Direct Blue 71, C.I. Direct Blue 78, C.I. Direct Blue 168, C.I. Direct Blue 202, C.I. Direct Violet 9, C.I. Direct Violet 51, C.I. Direct Brown 106, and C.I. Direct Brown 223.

The dye used may be a dye produced by a known method. Examples of the production method include the method described in JP H03-12606 A and the method described in JP S59-145255 A.

The thickness of the film is preferably 30 μm or less, more preferably 20 μm or less, still more preferably 15 μm or less, particularly preferably 10 μm or less.

When the thickness is within the above range, gas barrier properties can be further enhanced. Also, transparency can be further enhanced. Moreover, the drying time during production can be shortened to improve productivity.

The lower limit of the thickness of the film is not limited, and is, for example, 1 μm or more.

The polyvinyl alcohol resin is suitably used for production of a packaging film or film to be stretched having a thickness of 30 μm or less, in particular, for production of a packaging film or film to be stretched having a thickness of 20 μm or less. Normally, a thin packaging film or film to be stretched having a thickness of 30 μm or less is likely to break during stretching due to air bubbles or liquid droplets. Use of the polyvinyl alcohol resin can sufficiently suppress the inclusion of air bubbles and liquid droplets in the film even in production of a packaging film or film to be stretched having a thickness of 30 μm or less, preventing film breakage during stretching.

When the film is used as a polarizing layer of a polarizer, the thickness of the polarizing layer in the polarizer can be appropriately set in accordance with the purpose and application of the LCD including the polarizer. Normally, the thickness is 5 μm or more and 80 μm or less.

In the polarizer, the polarizing layer made of a stretched and dyed polyvinyl alcohol resin is vulnerable to heat and moisture, and therefore is preferably provided with a protective layer on its surface.

The material of the protective layer is not limited. Examples thereof include cellulose resins such as triacetylcellulose, polyester resins such as polyethylene naphthalate, cyclic polyolefin resins such as a cycloolefin polymer, and acrylic resins.

A film may be formed using the polyvinyl alcohol resin by any method. For example, a film may be produced by applying a polyvinyl alcohol resin aqueous solution, followed by drying.

Examples of the application method include a solution casting method (casting method), a roll coating method, a spin coating method, a screen coating method, a fountain coating method, a dipping method, and a spraying method. Examples of the roll coating method include a wire bar coating method, a reverse coating method, and a gravure coating method.

Examples of the drying method include a natural drying method and a heat-drying method at a temperature not higher than the glass transition temperature of the polyvinyl alcohol resin.

The polyvinyl alcohol resin aqueous solution may have any composition, and may contain, if necessary, additives such as a surface tension modifier, an antifoaming agent, a surfactant, a preservative, and a water-soluble plasticizer such as glycerol or polyethylene glycol.

The film may be provided in the state of being laminated on a support member.

The support member is preferably one capable of keeping the polyvinyl alcohol resin aqueous solution on its surface when the polyvinyl alcohol resin aqueous solution is applied thereon and capable of supporting the resulting polyvinyl alcohol resin film.

The material of the support member is not limited. Examples thereof include polyolefin resins, polyester resins, and acrylic resins. Examples of the polyolefin resins include polyethylene, polypropylene, an ethylene-vinyl acetate copolymer, and an ethylene-vinyl alcohol copolymer. Examples of the polyester resins include polyethylene terephthalate and polyethylene naphthalate. The material of the support member is preferably not a polyvinyl alcohol resin.

The above film can be suitably used as a packaging film such as a water-soluble packaging film for packaging chemicals such as agricultural chemicals, a film to be stretched, and the like.

A polarizer can be produced by dyeing the film after stretching.

The film may be dyed, for example, by a method including uniaxially stretching the film and adsorbing and orienting a dichroic dye such as iodine on the film.

A polarizing layer of the polarizer is preferably a polarizing film obtained by uniaxially stretching the film to about 2 to 8 times the original size and adsorbing and orienting the dichroic dye on the film.

A polyvinyl acetal resin can be obtained by adding an aldehyde to the polyvinyl alcohol resin in the presence of an acid catalyst to progress an acetalization reaction.

The present invention also encompasses a polyvinyl acetal resin that is an acetalized product of the polyvinyl alcohol resin of the present invention.

The degree of polymerization of the polyvinyl acetal resin is preferably 10,000 or more, and preferably 40,000 or less.

When the degree of polymerization is within the above range, the strength of the coating film obtainable by applying a slurry composition containing the polyvinyl acetal resin can be satisfyingly improved.

The degree of polymerization is more preferably 15,000 or more, and more preferably 25,000 or less.

Such a polyvinyl acetal resin has unprecedentedly high strength, and can further increase the strength of a laminated glass and provide thinner ceramic sheets.

The degree of acetalization of the polyvinyl acetal resin is preferably 50 mol % or higher, and preferably 80 mol % or lower.

When the degree of acetalization is within the above range, the polyvinyl acetal resin can have fully enhanced solubility in a solvent. In addition, the polyvinyl acetal resin has sufficiently enhanced compatibility with a plasticizer, which facilitates molding of the polyvinyl acetal resin.

The degree of acetalization is more preferably 60 mol % or higher and more preferably 75 mol % or lower.

The hydroxy group content of the polyvinyl acetal resin is preferably 16 mol % or more, and preferably 50 mol % or less.

When the hydroxy group content is within the above range, an inorganic powder can be better dispersed in production of a ceramic dispersed sheet. Also, the compatibility of the polyvinyl acetal resin with a plasticizer can be enhanced.

The hydroxy group content is more preferably 20 mol % or more and more preferably 33 mol % or less.

The present invention also encompasses a method for producing a polyvinyl acetal resin, including acetalizing the polyvinyl alcohol resin obtained by the above method for producing a polyvinyl alcohol resin with addition of an aldehyde.

The polyvinyl alcohol resin of the present invention has an ultra-high molecular weight and is excellent in toughness and transparency. The polyvinyl alcohol resin can provide, through acetalization, a polyvinyl acetal resin having an ultra-high molecular weight, excellent toughness, and excellent transparency.

The acetalization may be carried out by a known method and is preferably carried out in a water solvent, a solvent mixture containing water and an organic solvent compatible with water, or an organic solvent.

The organic solvent compatible with water may be, for example, an alcoholic organic solvent.

Examples of the organic solvent include alcoholic organic solvents, aromatic organic solvents, aliphatic ester solvents, ketone solvents, lower paraffin solvents, ether solvents, amide solvents, and amine solvents.

Examples of the alcoholic organic solvents include methanol, ethanol, n-propanol, isopropanol, n-butanol, and tert-butanol.

Examples of the aromatic organic solvents include xylene, toluene, ethyl benzene, and methyl benzoate.

Examples of the aliphatic ester solvents include methyl acetate, ethyl acetate, butyl acetate, methyl propionate, ethyl propionate, methyl butyrate, ethyl butyrate, methyl acetoacetate, and ethyl acetoacetate.

Examples of the ketone solvents include acetone, methyl ethyl ketone, methyl isobutyl ketone, cyclohexanone, methyl cyclohexanone, benzophenone, and acetophenone.

Examples of the lower paraffin solvents include hexane, pentane, octane, cyclohexane, and decane.

Examples of the ether solvents include diethyl ether, tetrahydrofuran, ethylene glycol dimethyl ether, ethylene glycol diethyl ether, and propylene glycol diethyl ether.

Examples of the amide solvents include N, N-dimethylformamide, N, N-dimethylacetamide, N-methylpyrrolidone, and acetanilide.

Examples of the amine solvents include ammonia, trimethylamine, triethylamine, n-butylamine, di-n-butylamine, tri-n-butylamine, aniline, N-methylaniline, N, N-dimethylaniline, and pyridine.

These may be used alone or in admixture of two or more thereof. From the standpoint of the ability to dissolve resin and easy purification, particularly preferred among these are ethanol, n-propanol, isopropanol, and tetrahydrofuran.

The acetalization is preferably carried out in the presence of an acid catalyst.

The acid catalyst is not limited, and examples thereof include mineral acids such as sulfuric acid, hydrochloric acid, nitric acid, and phosphoric acid, carboxylic acids such as formic acid, acetic acid, and propionic acid, and sulfonic acids such as methanesulfonic acid, ethanesulfonic acid, benzenesulfonic acid, and p-toluenesulfonic acid. These acid catalysts may be used alone, or two or more types of compounds may be used in combination. Preferred among these are hydrochloric acid, nitric acid, and sulfuric acid, and particularly preferred is hydrochloric acid.

The aldehyde used for the acetalization may be an aldehyde containing a C1-C10 chain aliphatic group, a C1-C10 cyclic aliphatic group, or a C1-C10 aromatic group. The aldehyde used may be a conventionally known aldehyde. The aldehyde used for the acetalization reaction is not limited, and examples thereof include aliphatic aldehydes and aromatic aldehydes.

Examples of the aliphatic aldehydes include formaldehyde, acetaldehyde, propionaldehyde, n-butyraldehyde, isobutyraldehyde, n-valeraldehyde, n-hexylaldehyde, 2-ethylbutyraldehyde, 2-ethylhexylaldehyde, n-heptylaldehyde, n-octylaldehyde, n-nonylaldehyde, n-decylaldehyde, and amylaldehyde.

Examples of the aromatic aldehydes include aromatic aldehydes such as benzaldehyde, cinnamaldehyde, 2-methylbenzaldehyde, 3-methylbenzaldehyde, 4-methylbenzaldehyde, p-hydroxybenzaldehyde, m-hydroxybenzaldehyde, phenylacetaldehyde, and β-phenylpropionaldehyde.

These aldehydes may be used alone, or two or more types thereof may be used in combination. Preferred among these aldehydes are formaldehyde, acetaldehyde, butyraldehyde, 2-ethylhexylaldehyde, and n-nonylaldehyde because they have excellent acetalization reactivity and can give a sufficient internal plasticization effect and in turn favorable flexibility to the resulting resin. More preferred are formaldehyde, acetaldehyde, and butyraldehyde because an adhesive composition particularly excellent in impact resistance and adhesiveness to metal can be obtained.

The amount of the aldehyde to be added can be appropriately determined according to the degree of acetalization of the aimed polyvinyl acetal resin. In particular, the amount is preferably 50 mol % or more and 95 mol % or less, more preferably 55 mol % or more and 90 mol % or less relative to 100 mol % of the polyvinyl alcohol resin. The amount in the range is preferred because the acetalization reaction can be efficiently carried out and unreacted aldehyde can be easily removed.

The retention time after the reaction is preferably 1.5 hours or longer, more preferably 2 hours or longer, though it depends on other conditions. The acetalization reaction can be allowed to proceed sufficiently by setting the retention time as described above.

The retention temperature after the reaction is preferably 15° C. or higher, more preferably 20° C. or higher. When the retention temperature is set as above, the acetalization reaction can fully proceed.

The polyvinyl acetal resin is excellent in toughness and transparency, and can be used for applications that take advantage of these properties.

For example, the polyvinyl acetal resin can be used for an application of an interlayer film for a laminated glass. The present invention also encompasses an interlayer film for a laminated glass containing the polyvinyl acetal resin.

The interlayer film for a laminated glass can be obtained by forming the polyvinyl acetal resin and the plasticizer into a sheet using an extruder.

The interlayer film for a laminated glass is sandwiched between two glass sheets and hot-pressed to provide a laminated glass.

Even when the interlayer film includes other resin layer (s) for imparting characteristics to the laminated glass, the interlayer film has sufficient strength because the polyvinyl acetal resin used therein is excellent in toughness and transparency. In addition, a thinner laminated glass can be produced.

The polyvinyl acetal resin can be also suitably used in binder compositions such as binders for producing multilayer ceramic capacitors, binders for coating materials, and binders for secondary batteries.

For example, many multilayer ceramic capacitors are mounted in electronic devices such as smartphones, and miniaturization thereof is needed. Use of the polyvinyl acetal resin can contribute to production of ceramic sheets with higher strength.

In a multilayer ceramic capacitor, the binder is thermally decomposed. When a large amount of firing residue is left, the reliability of the capacitor is lowered. Use of the polyvinyl acetal resin can reduce the amount of the binder to be added, thereby reducing the firing residue.

### Advantageous Effects of Invention

The present invention can provide an ultra-high molecular weight polyvinyl alcohol resin that can provide, when acetalized, a resin film having high strength and high transparency. The present invention can also provide a polyvinyl acetal resin, a method for producing a polyvinyl alcohol resin, and a method for producing a polyvinyl acetal resin.

### DESCRIPTION OF EMBODIMENTS

The present invention will be described in more detail with reference to examples below, but the present invention is not limited only to these examples.

### Example 1

### (Production of Polyvinyl Acetate Resin (PVAc))

### (Polymerization Step)

A 2-L separable flask equipped with a stirrer, a condenser, a thermometer, a water bath, and a nitrogen gas inlet was provided. To the flask were charged 900 parts by weight of water and 100 parts by weight of vinyl acetate (VAc) as a monomer. The contents were stirred with a stirring blade at 150 rpm to disperse the monomer in water, whereby a monomer mixed solution was obtained.

The resulting monomer mixed solution was bubbled using nitrogen gas for 20 minutes. Thus, dissolved oxygen was removed. Then, the separable flask system was purged with nitrogen gas, and the temperature was raised with stirring until the water bath reached 60° C. Separately, a polymerization initiator solution was prepared by dissolving 0.03 parts by weight of ammonium dodecylsulfonate (DSA, solubility in water at 25° C. of 10 g/100 g) as a water-soluble surfactant and 0.12 parts by weight of ammonium persulfate (APS) as a polymerization initiator. The polymerization initiator solution was added to the monomer mixed solution to initiate polymerization.

Twelve hours after the start of polymerization, the polymerization was terminated by cooling the solution to room temperature, whereby an aqueous solution (polymerization slurry) containing a polyvinyl acetate resin having a sulfone group at one molecular end of the main chain was obtained.

A 2-g portion of the resulting aqueous solution was dried in an oven at 150° C. to determine the resin solid content. The aqueous solution had a resin solid content of 10% by weight, and it was confirmed that all the monomers used were reacted.

The polymerization slurry was analyzed by a zeta sizer. The polyvinyl acetate resin was found to have an average particle size of 0.2 μm and a CV value of the particle size of 4%.

### (Recovery Step)

To the resulting aqueous solution containing a polyvinyl acetate resin was added 0.01 parts by weight of n-octylammonium bromide (TOAB, solubility in water at 25° C. of 0.005 g/100 g, available from Tokyo Chemical Industry Co., Ltd.) as a cationic surfactant, whereby a resin aqueous solution was obtained.

The resulting resin aqueous solution was dehydrated using a filter cloth, and dried in a vacuum dryer set at 27° C. for 18 hours, whereby a polyvinyl acetate resin was recovered.

The resulting polyvinyl acetate resin was subjected to measurement of the weight average molecular weight (Mw) and the number average molecular weight (Mn) in terms of polystyrene by gel permeation chromatography using LF-804 (available from Shoko) as a column. The polyvinyl acetate resin was found to have a Mw of 1, 800,000 and a Mn of 900,000.

### (Production of Polyvinyl Alcohol Resin (PVA))

The resulting polyvinyl acetate resin was added to methanol (MeOH) as a solvent to a concentration of 6% by weight. To this methanol solution of the polyvinyl acetate resin was added a methanol solution of sodium hydroxide (NaOH) such that the added amount of NaOH was 0.05 mol/1 mol of resin, followed by saponification at 40° C. Then, the reaction product was washed with ethyl acetate and dried in a vacuum oven, whereby a polyvinyl alcohol resin (PVA) was obtained.

The degree of saponification of the PVA measured in conformity with JIS K6726 was 87.7 mol %.

The cloud point of the PVA was visually measured, and was 90° C. or higher.

The proportion of undissolved components when the PVA was dissolved in water at a concentration of 4% by weight was measured by a filtration method, and was 0% by weight. Specifically, the proportion of undissolved components was measured by the following method. First, a resin aqueous solution having a concentration of 4% by weight was allowed to stand still for 12 hours or longer, the temperature was raised to 80° C., and then the temperature was lowered to room temperature by allowing the solution to stand still. Then, using a metal mesh (#100 mesh), water and water-absorbed and swollen resin were separated. The separated resin was dried at 60° C. for three hours, and the weight of the resin including the metal mesh after drying was measured. The proportion of undissolved components was calculated using the following formula.

$$Proportion of undissolved components ( \% by weight ) = 100 \times ( W 1 - W 2 ) / W 0$$

(W0: initial weight of resin, W1: weight of resin including metal mesh after drying, W2: initial weight of metal mesh)

The weight average molecular weight (Mw) and the number average molecular weight (Mn) were similarly measured by GPC, and the polyvinyl alcohol resin was found to have a Mw of 1,800,000 and a Mn of 900,000.

In GPC analysis, Shodex KF-807 available from Showa Denko K.K. was used as a separation column. The evaluation was performed on a sample prepared by diluting the PVA with THE to 0.01 to 0.05 wt %. The weight average molecular weight (Mw) and the number average molecular weight (Mn) were calculated based on a calibration curve created using high molecular weight standard polystyrene EasiVial PS-H available from GL Sciences Inc. as a standard substance.

### (Production of Polyvinyl Acetal Resin (PVB))

A 275-g portion of the resulting polyvinyl alcohol resin was added to 2,890 parts by weight of pure water and dissolved by heating. The temperature of the reaction system was adjusted to 12° C., and 201 parts by weight of a 35 wt % hydrochloric acid catalyst and 148 parts by weight of n-butyraldehyde were added thereto. With this temperature maintained, the reaction product was deposited.

Then, the reaction system was warmed to 45° C. and held at that temperature for three hours for completion of the reaction. The reaction product was washed with excess water to wash off unreacted n-butyraldehyde, and the hydrochloric acid catalyst was neutralized. Through washing with water and drying, a white powdery polyvinyl acetal resin (PVB) was obtained.

The resulting polyvinyl acetal resin was subjected to measurement of the weight average molecular weight in terms of polystyrene by gel permeation chromatography using LF-804 (available from Shoko) as a column. The polyvinyl acetal resin was found to have a weight average molecular weight of 1,820,000.

### Examples 2 to 10

A polyvinyl acetate resin and a polyvinyl alcohol resin were obtained as in Example 1, except that the water-soluble surfactant and the polymerization initiator of the types shown in Table 1 were added to obtain the formulation shown in Table 1.

A polyvinyl acetal resin was obtained as in Example 1, except that n-butyraldehyde was added to obtain the formulation shown in Table 3.

The following water-soluble surfactant and polymerization initiators were used.

### <Water-Soluble Surfactant>

Ammonium p-toluenesulfonate: solubility in water at 25° C. of 63 g/100 g

### <Polymerization Initiator>

VA-057: 2,2′-azobis [N-(2-carboxyethyl)-2-methylpropionamidine]tetrahydrate (available from Fujifilm Wako Pure Chemical Industries, Ltd.)
Tetramethylammonium peroxodisulfate
P-Toluenesulfonyl peroxide
Peroxodisulfinic acid
VA-61: 2,2′-azobis [2-(2-imidazolin-2-yl) propane]
V-50: 2,2′-azobis(2-methylpropionamidine) dihydrochloride (available from Fujifilm Wako Pure Chemical Industries, Ltd.)
VA-086: 2,2′-azobis [2-methyl-N-(2-hydroxyethyl) propionamide] (available from Fujifilm Wako Pure Chemical Industries, Ltd.)

### Examples 11 to 16

An aqueous solution (polymerization slurry) containing a polyvinyl acetate resin (PVAc) was obtained as in Example 1, except that vinyl acetate, water, a water-soluble surfactant, and a polymerization initiator were added to obtain the formulation shown in Table 1 and that the recovery step was not carried out.

A polyvinyl alcohol resin was obtained as in Example 1, except that the compound shown in Table 2 was added as a saponification catalyst to the polymerization slurry obtained above.

A polyvinyl acetal resin was obtained as in Example 1, except that the polyvinyl alcohol resin obtained above was used.

The following saponification catalysts were used.

### <Saponification Catalyst>

Dialkylamine compound: diethylamine
Trialkylamine compound: triethylamine (solubility in water at 25° C. of 8 g/100 g)
Tributylamine: solubility in water at 25° C. of 0.3 g/100 g

### Examples 17 to 23

A polyvinyl acetate resin was obtained as in Example 1, except that vinyl acetate, water, a water-soluble surfactant, a polymerization initiator, and a cationic surfactant were added to obtain the formulation shown in Table 1.

A polyvinyl alcohol resin was obtained as in Example 1, except that the type of solvent and the amount of the saponification catalyst were changed as shown in Table 2.

A polyvinyl acetal resin was obtained as in Example 1, except that the polyvinyl alcohol resin obtained above was used.

The following cationic surfactant was used.

### <Cationic Surfactant>

Stearic acid dimethylaminopropylamide: solubility in water at 25° C. of 1 mg/100 g

### Comparative Example 1

A 2-L separable flask equipped with a stirrer, a condenser, a thermometer, a water bath, and a nitrogen gas inlet was provided. To the flask were charged 300 parts by weight of ion-exchanged water, 12 parts by weight of Nonipol 400 (available from Sanyo Chemical Industries, Ltd.) as a surfactant, 0.05 parts by weight of iron (II) sulfate heptahydrate, and 0.5 parts by weight of sodium formaldehyde sulfoxylate, and dissolved with stirring. To the flask were added 300 parts by weight of vinyl acetate degassed at 60° C. and 100 parts by weight of methanol under a stream of nitrogen, followed by mixing at room temperature for 30 minutes. The mixture liquid was then cooled to 20° C. under a nitrogen atmosphere, to which 0.03% hydrogen peroxide solution separately prepared using degassed ion-exchanged water was uniformly and continuously dropped at 12 parts/hr to initiate polymerization. After two hours from the start, addition of the hydrogen peroxide solution was stopped when the rate of polymerization reached 48%, and 1.0 parts of hydroquinone was added to stop the polymerization, whereby an aqueous solution (polymerization slurry) containing a polyvinyl acetate resin was obtained.

The polymerization slurry was analyzed using a zeta sizer. The polyvinyl acetate resin was found to have an average particle size of 0.2 μm and a CV value of 20%.

The polymerization slurry obtained above was spray-dried, whereby a polyvinyl acetate resin composition was obtained.

The polyvinyl acetate resin obtained above was soluble in acetone and methanol. The polyvinyl acetate resin had a molecular weight of 1,000,000.

A polyvinyl alcohol resin and a polyvinyl acetal resin were obtained as in Example 1, except that the polyvinyl acetate resin obtained above was used.

### Comparative Example 2

A 2-L separable flask equipped with a stirrer, a condenser, a thermometer, a water bath, and a nitrogen gas inlet was provided. To the 2-L separable flask was charged 900 parts by weight of water and 100 parts by weight of vinyl acetate as a monomer. To the flask were added 2.0 parts by weight of azobisisobutyronitrile (AIBN) as a polymerization initiator and 12 parts by weight of sodium dodecylsulfonate as an emulsifier. The reaction system was emulsified using a homogenizer.

The emulsified monomer mixed solution was bubbled with nitrogen gas for 20 minutes. Thus, dissolved oxygen was removed. Then, the separable flask system was purged with nitrogen gas, and the temperature was raised with stirring until the water bath reached 60ºC, whereby polymerization was initiated. Twelve hours after the start of polymerization, the solution was cooled to room temperature and the polymerization was terminated, whereby an aqueous solution (polymerization slurry) containing a polyvinyl acetate resin having an isobutyronitrile group at one molecular end of the main chain was obtained.

A 2-g portion of the resulting aqueous solution was dried in an oven at 150° C. to determine the resin solid content. The resin solid content concentration of the aqueous solution was 3% by weight, and it was confirmed that the monomers were partly reacted.

The polymerization slurry was analyzed by a zeta sizer. The polyvinyl acetate resin was found to have an average particle size of 10 μm and a CV value of 40%.

The resulting polymerization slurry was dehydrated using a filter cloth and dried in a vacuum dryer set at 27° C. for 18 hours, whereby a polyvinyl acetate resin was obtained.

The polyvinyl acetate resin obtained above was soluble in acetone and methanol. The polyvinyl acetate resin had a molecular weight of 150,000.

A polyvinyl alcohol resin was obtained as in Example 1, except that the polyvinyl acetate resin obtained above was used.

A polyvinyl acetal resin was obtained as in Example 1, except that the polyvinyl alcohol resin obtained above was used and the amounts of the polyvinyl alcohol resin, water, and aldehyde added were as shown in Table 3.

### Comparative Examples 3 to 5

A polyvinyl acetate resin was obtained as in Example 1, except that the type and amount of the water-soluble surfactant were as shown in Table 1.

A polyvinyl alcohol resin was obtained as in Example 1, except that the type of the solvent and the amount of the saponification catalyst added were as shown in Table 2.

A polyvinyl acetal resin was obtained as in Example 1, except that the polyvinyl alcohol resin obtained above was used.

The following water-soluble surfactant was used.

### <Water-Soluble Surfactant>

Polycarboxylic acid: Demol P (Kao Corporation)

### Comparative Example 6

A 2-L separable flask equipped with a stirrer, a condenser, a thermometer, a water bath, and a nitrogen gas inlet was provided. The 2-L separable flask was charged with 700 parts by weight of water and 100 parts by weight of vinyl acetate as a monomer. To the flask was further added 2.3 parts by weight of sodium dodecylsulfonate as an emulsifier, followed by emulsification of the reaction system using a homogenizer.

A polymerization initiator solution was prepared by dissolving 1.2 parts by weight of ammonium persulfate (APS) as a polymerization initiator in 200 parts by weight of water. The emulsified monomer mixed solution was bubbled with nitrogen gas for 20 minutes. Thus, dissolved oxygen was removed. Then, the separable flask system was purged with nitrogen gas, and the temperature was raised with stirring until the water bath reached 60° C. To the system was dropwise added the polymerization initiator solution to initiate polymerization. Twelve hours after the start of polymerization, the solution was cooled to room temperature and the polymerization was terminated, whereby an aqueous solution (polymerization slurry) containing a polyvinyl acetate resin having a sulfone group at one molecular end of the main chain was obtained.

A 2-g portion of the resulting aqueous solution was dried in an oven at 150° C. to determine the resin solid content. The resin solid content concentration of the aqueous solution was 3% by weight, and it was confirmed that the monomers used were partly reacted.

The polymerization slurry was analyzed by a zeta sizer. The polyvinyl acetate resin was found to have an average particle size of 0.2 μm and a CV value of 20%.

The resulting polymerization slurry was dehydrated using a filter cloth and dried in a vacuum dryer set at 27° C. for 18 hours, whereby a polyvinyl acetate resin was obtained.

The polyvinyl acetate resin obtained above was soluble in acetone and methanol. The polyvinyl acetate resin had a molecular weight of 900,000.

A polyvinyl alcohol resin was obtained as in Example 1, 1 except that the polyvinyl acetate resin obtained above was used.

A polyvinyl acetal resin was obtained as in Example 1, except that the polyvinyl alcohol resin obtained above was used and the amounts of the polyvinyl alcohol resin, water, and the aldehyde added were as shown in Table 3.

### (Evaluation)

### (Measurement on Polyvinyl Alcohol Resin)

For each of the obtained polyvinyl alcohol resins, the amount of decomposition gas at 400° C. to 600° C. derived from the combustion of the water-soluble surfactant and the amount of decomposition gas at 200° C. to 300° C. derived from the decomposition of the polyvinyl alcohol resin itself were measured using a thermogravimetric mass spectrometer (TG-MS device, available from Netzsch). Based on the obtained values, the amount of the water-soluble surfactant in the polyvinyl alcohol resin was calculated.

Also, the amount of the cationic surfactant, the amount of the dialkylamine compound, and the amount of the trialkylamine compound were calculated by GC-MS.

### (PVA Film)

To 190 parts by weight of water were added 10 parts by weight of the polyvinyl alcohol resin obtained above, 40 parts by weight of glycerol as a plasticizer, and 0.4 parts by weight of polyether silicone (KF-642 available from Shin-Etsu Chemical Co., Ltd.) as an antifoaming agent, whereby a polyvinyl alcohol resin aqueous solution was prepared. The resulting aqueous solution was applied to a release PET film to form a liquid coating, which was cast on a chromium plated drum heated to 80° C. and dried for three minutes, whereby a 40-μm PVA film was obtained.

The PVA film obtained above was left in an environment of 23° C. and 50% RH for 24 hours, and the film was cut into a size of 100 mm×15 mm, whereby a measurement sample (PVA film) was produced. A tensile test was performed on the measurement sample in conformity with JIS K7113 at a temperature of 23° C., a humidity of 50%, and a peel speed of 100 mm/min to determine the breaking strength (kgf/mm²) and the elongation at break (%).

### (PVB Resin Sheet)

The polyvinyl acetal resin obtained above in an amount of 10 parts by weight was added to 90 parts by weight of an ethanol/toluene solvent mixture (weight ratio: 1:1), and dissolved with stirring. Thus, a resin sheet composition was obtained.

The resulting resin sheet composition was applied to a release-treated PET film using a coater to a thickness after drying of 20 μm, followed by heating and drying. Thus, a measurement sample (resin sheet) was produced.

The measurement sample was stretched at a tensile speed of 20 mm/min using an Autograph (AGS-J, available from Shimadzu Corporation) by a method in conformity with JIS K7113, and the breaking stress was measured. The strength was evaluated according to the following criteria.
∘ (Good): breaking stress of 100 MPa or more
x (Poor): breaking stress of less than 100 MPa

### (Interlayer Film for Laminated Glass)

The polyvinyl acetal resin obtained above in an amount of 100 parts by weight and 40 parts by weight of triethylene glycol-di-2-ethylbutyrate as a plasticizer were mixed, and the mixture was thoroughly melt-kneaded using a mixing roll and then press-molded using a press molding machine at 150° C. for 30 minutes. Thus, a resin (interlayer film for a laminated glass) having a thickness of 0.3 mm was obtained.

The resulting resin film was sandwiched between two sheets of transparent float glass (30 cm in length×30 cm in width×3 mm in thickness), and placed in a rubber bag, followed by degassing at a vacuum of 20 torr for 20 minutes. The resulting laminate was transferred to an oven at 90° C. and vacuum-pressed while being held for 30 minutes. Thus, a laminated glass was obtained.

The transparency of the resulting laminated glass was determined in conformity with JIS R3205. In addition, the falling ball impact peeling characteristics was determined in conformity with JIS R3205, and the height at which visible cracks occurred in the falling ball test was measured. The strength was evaluated based on the following criteria.
∘ (Good): 6.0 m or more
x (Poor): less than 6.0 m

TABLE 1

| | Polymerization step | | | | | | |
|---|---|---|---|---|---|---|---|
| | VAc | Water | Water-soluble surfactant | | Polymerization initiator | | |
| | Parts | Parts | | Parts | | | Parts |
| | by | by | | by | | Terminal | by |
| | weight | weight | Type | weight | Type | group | weight |
| Example 1 | 100 | 900 | DSA | 0.03 | APS | Sulfone group | 0.12 |
| Example 2 | 100 | 900 | DSA | 0.03 | VA-057 | 2-Carboxyethyl | 0.12 |
| | | | | | | amidine group | |
| | | | | | | (Carboxy group) | |
| Example 3 | 100 | 900 | DSA | 0.03 | Tetramethylammonium | Alkylsulfonyl group | 0.12 |
| | | | | | peroxodisulfate | | |
| Example 4 | 100 | 900 | DSA | 0.03 | P-Toluenesulfonic acid | Aromatic sulfonyl | 0.12 |
| | | | | | peroxide | group | |
| Example 5 | 100 | 900 | DSA | 0.03 | Peroxodisulfinic acid | Sulfine group | 0.12 |
| Example 6 | 100 | 900 | DSA | 0.03 | VA-61 | Imidazoline group | 0.12 |
| Example 7 | 100 | 900 | DSA | 0.03 | V-50 | Amide group | 0.12 |
| Example 8 | 100 | 900 | DSA | 0.03 | VA-086 | Hydroxy group | 0.12 |
| Example 9 | 100 | 900 | Ammonium P- | 0.03 | APS | Sulfone group | 0.12 |
| | | | toluenesulfonate | | | | |
| Example 10 | 100 | 900 | — | 0 | APS | Sulfone group | 0.12 |
| Example 11 | 10 | 990 | DSA | 0.03 | APS | Sulfone group | 0.12 |
| Example 12 | 100 | 900 | DSA | 0.03 | APS | Sulfone group | 0.12 |
| Example 13 | 100 | 900 | DSA | 0.03 | APS | Sulfone group | 0.12 |
| Example 14 | 100 | 900 | DSA | 0.03 | APS | Sulfone group | 0.04 |
| Example 15 | 100 | 900 | DSA | 0.03 | APS | Sulfone group | 0.02 |
| Example 16 | 100 | 900 | DSA | 0.03 | APS | Sulfone group | 0.12 |
| Example 17 | 100 | 900 | DSA | 0.03 | APS | Sulfone group | 0.12 |
| Example 18 | 100 | 900 | DSA | 0.03 | APS | Sulfone group | 0.12 |
| Example 19 | 200 | 900 | — | 0 | APS | Sulfone group | 0.12 |
| Example 20 | 100 | 900 | DSA | 0.03 | APS | Sulfone group | 0.12 |
| Example 21 | 100 | 900 | DSA | 0.03 | APS | Sulfone group | 0.12 |
| Example 22 | 100 | 900 | DSA | 0.03 | APS | Sulfone group | 0.12 |
| Example 23 | 100 | 900 | DSA | 0.03 | APS | Sulfone group | 0.12 |
| Comparative | Conventional method (redox polymerization by iron | | | | | | |
| Example 1 | (II) sulfate and hydrogen peroxide) | | | | | | |
| Comparative | 100 | 900 | DSA | 12 | AlBN | Isobutyronitrile | 2 |
| Example 2 | | | | | | group | |
| Comparative | 100 | 900 | DSA | 0.03 | 2,2′-Azobis(2- | Propionitrile | 0.12 |
| Example 3 | | | | | methylpropanenitrile) | | |
| Comparative | 100 | 900 | DSA | 0.5 | APS | Sulfone group | 0.12 |
| Example 4 | | | | | | | |
| Comparative | 100 | 900 | Polycarboxylic | 0.3 | APS | Sulfone group | 0.4 |
| Example 5 | | | acid | | | | |
| Comparative | 100 | 700 | DSA | 2.3 | APS | Sulfone group | 1.2 |
| Example 6 | | | | | | | |

| | Recovery step | | PVAc | | | | |
|---|---|---|---|---|---|---|---|
| | Cationic surfactant | | Average | | | | |
| | | Parts | particle | CV | | | |
| | | by | size | value | Mw | Mn | Mw/ |
| | Type | weight | μm | % | ×10⁴ | ×10⁴ | Mn |
| Example 1 | TOAB | 0.01 | 0.2 | 4 | 180 | 90 | 2 |
| Example 2 | TOAB | 0.01 | 0.5 | 6 | 260 | 100 | 2.6 |
| Example 3 | TOAB | 0.01 | 0.4 | 5 | 200 | 90 | 2.2 |
| Example 4 | TOAB | 0.01 | 0.7 | 6 | 380 | 160 | 2.4 |
| Example 5 | TOAB | 0.01 | 0.01 | 5 | 100 | 35 | 2.9 |
| Example 6 | TOAB | 0.01 | 0.2 | 5 | 200 | 110 | 1.8 |
| Example 7 | TOAB | 0.01 | 0.01 | 4 | 270 | 90 | 3 |
| Example 8 | TOAB | 0.01 | 0.2 | 7 | 210 | 100 | 2.1 |
| Example 9 | TOAB | 0.01 | 0.2 | 4 | 200 | 100 | 2 |
| Example 10 | TOAB | 0.01 | 0.2 | 7 | 200 | 80 | 2.5 |
| Example 11 | None | | 0.005 | 4 | 100 | 50 | 2 |
| Example 12 | None | | 0.2 | 4 | 180 | 90 | 2 |
| Example 13 | None | | 0.2 | 4 | 180 | 90 | 2 |
| Example 14 | None | | 0.5 | 7 | 410 | 150 | 2.7 |
| Example 15 | None | | 0.6 | 8 | 440 | 120 | 3.7 |
| Example 16 | None | | 0.2 | 4 | 180 | 90 | 2 |
| Example 17 | Dimethylaminopro- | 0.01 | 0.2 | 4 | 180 | 90 | 2 |
| | pylamide stearate | | | | | | |
| Example 18 | TOAB | 0.001 | 0.2 | 4 | 180 | 90 | 2 |
| Example 19 | TOAB | 0.01 | 0.2 | 15 | 180 | 52 | 3.5 |
| Example 20 | TOAB | 0.01 | 0.2 | 4 | 180 | 90 | 2 |
| Example 21 | TOAB | 0.01 | 0.2 | 4 | 180 | 90 | 2 |
| Example 22 | TOAB | 0.01 | 0.2 | 4 | 180 | 90 | 2 |
| Example 23 | TOAB | 0.01 | 0.2 | 4 | 180 | 90 | 2 |
| Comparative | Conventional method (redox polymerization by iron | | 0.2 | 20 | 100 | 20 | 5 |
| Example 1 | (II) sulfate and hydrogen peroxide) | | | | | | |
| Comparative | None | | 10 | 40 | 15 | 2.4 | 6.3 |
| Example 2 | | | | | | | |
| Comparative | TOAB | 0.01 | 20 | 50 | 15 | 3 | 5 |
| Example 3 | | | | | | | |
| Comparative | TOAB | 0.01 | 30 | 30 | 30 | 10 | 3 |
| Example 4 | | | | | | | |
| Comparative | TOAB | 0.01 | 40 | 30 | 30 | 7 | 4.3 |
| Example 5 | | | | | | | |
| Comparative | TOAB | 0.01 | 0.2 | 20 | 90 | 30 | 3 |
| Example 6 | | | | | | | |

TABLE 2

| | Saponification step | | | | | | | | | |
|---|---|---|---|---|---|---|---|---|---|---|
| | | | Saponification | | PVA | | | | | |
| | PVAc | | catalyst | | | | | | Degree of | |
| | Concen- | | | Amount | | | | | saponi- | Cloud |
| | tration | Solvent | | ratio | Terminal | Mw | Mn | Mw/ | fication | point |
| | (wt %) | Type | Type | mol/PVAc | group | ×10⁴ | ×10⁴ | Mn | mol % | ° C. |
| Example 1 | 6 | MeOH | NaOH | 0.05 | Sulfone group | 180 | 90 | 2 | 87.7 | 90° C. or higher |
| Example 2 | 6 | MeOH | NaOH | 0.05 | Carboxy group | 260 | 100 | 2.6 | 97 | 90° C. or higher |
| Example 3 | 6 | MeOH | NaOH | 0.05 | Alkylsulfonyl group | 200 | 90 | 2.2 | 81 | 45 |
| Example 4 | 6 | MeOH | NaOH | 0.05 | Aromatic sulfonyl group | 380 | 160 | 2.4 | 95 | 90° C. or higher |
| Example 5 | 6 | MeOH | NaOH | 0.05 | Sulfine group | 100 | 35 | 2.9 | 93 | 90° C. or higher |
| Example 6 | 6 | MeOH | NaOH | 0.05 | Imidazoline group | 200 | 110 | 1.8 | 79 | 43 |
| Example 7 | 6 | MeOH | NaOH | 0.05 | Amide group | 270 | 90 | 3 | 77 | 38 |
| Example 8 | 6 | MeOH | NaOH | 0.05 | Hydroxy group | 210 | 100 | 2.1 | 90 | 90° C. or higher |
| Example 9 | 6 | MeOH | NaOH | 0.05 | Sulfone group | 200 | 100 | 2 | 95 | 90° C. or higher |
| Example 10 | 6 | MeOH | NaOH | 0.05 | Sulfone group | 200 | 80 | 2.5 | 95 | 90° C. or higher |
| Example 11 | 6 | — | Diethyl | 0.05 | Sulfone group | 100 | 50 | 2 | 72 | 36 |
| Example 12 | 6 | — | Diethyl | 0.05 | Sulfone group | 180 | 90 | 2 | 74 | 39 |
| | | | amine | | | | | | | |
| Example 13 | 6 | — | Triethyl | 0.05 | Sulfone group | 180 | 90 | 2 | 74 | 39 |
| | | | amine | | | | | | | |
| Example 14 | 6 | — | Diethyl | 0.05 | Sulfone group | 410 | 150 | 2.7 | 73 | 37 |
| | | | amine | | | | | | | |
| Example 15 | 6 | — | Diethyl | 0.05 | Sulfone group | 440 | 120 | 3.7 | 75 | 40 |
| | | | amine | | | | | | | |
| Example 16 | 6 | — | Tributyl | 0.05 | Sulfone group | 180 | 90 | 2 | 70 | 35 |
| | | | amine | | | | | | | |
| Example 17 | 6 | MeOH | NaOH | 0.05 | Sulfone group | 180 | 90 | 2 | 89 | 90° C. or higher |
| Example 18 | 6 | MeOH | NaOH | 0.05 | Sulfone group | 180 | 90 | 2 | 92 | 90° C. or higher |
| Example 19 | 6 | MeOH | NaOH | 0.05 | Sulfone group | 180 | 52 | 3.5 | 88 | 90° C. or higher |
| Example 20 | 6 | Acetone | NaOH | 0.05 | Sulfone group | 180 | 90 | 2 | 70 | 35 |
| Example 21 | 6 | Acetone | NaOH | 0.05 | Sulfone group | 180 | 90 | 2 | 75 | 40 |
| Example 22 | 6 | MeOH | NaOH | 0.08 | Sulfone group | 180 | 90 | 2 | 99 | Insoluble in water |
| Example 23 | 6 | MeOH | NaOH | 0.12 | Sulfone group | 180 | 90 | 2 | 99.5 | Insoluble in water |
| Comparative | 6 | MeOH | NaOH | 0.05 | — | 100 | 20 | 5 | 98.5 | 90° C. or higher |
| Example 1 | | | | | | | | | | |
| Comparative | 6 | MeOH | NaOH | 0.05 | Isobutyronitrile group | 15 | 2.4 | 6.3 | 97 | 90° C. or higher |
| Example 2 | | | | | | | | | | |
| Comparative | 6 | MeOH | NaOH | 0.05 | Propionitrile group | 15 | 3 | 3 | 97 | 90° C. or higher |
| Example 3 | | | | | | | | | | |
| Comparative | 6 | MeOH | NaOH | 0.05 | Sulfone group | 30 | 10 | 3 | 95 | 90° C. or higher |
| Example 4 | | | | | and the like | | | | | |
| Comparative | 6 | Acetone | NaOH | 0.03 | Sulfone group | 30 | 7 | 4.3 | 65 | Cloudy at room |
| Example 5 | | | | | and the like | | | | | temperature |
| Comparative | 6 | MeOH | NaOH | 0.05 | Sulfone group | 90 | 30 | 3 | 88 | 90° C. or higher |
| Example 6 | | | | | and the like | | | | | |

| | PVA | | | | | |
|---|---|---|---|---|---|---|
| | Water solubility | | | | Evaluation | |
| | (Proportion of | Water- | | Dialkylamine/ | PVA film strength | |
| | undissolved | soluble | Cationic | trialkylamine | Breaking | Elongation |
| | components) | surfactant | surfactant | content | strength | at break |
| | wt % | wt % | wt % | wt % | kgf/mm² | % |
| Example 1 | 0 | 0.01 | 0.0002 | 0 | 9.4 | 400 |
| Example 2 | 0 | 0.01 | 0.0002 | 0 | 10.4 | 460 |
| Example 3 | 0 | 0.01 | 0.0002 | 0 | 9.4 | 400 |
| Example 4 | 0 | 0.02 | 0.0002 | 0 | 16.6 | 730 |
| Example 5 | 0 | 0.01 | 0.0002 | 0 | 4 | 160 |
| Example 6 | 0 | 0.01 | 0.0002 | 0 | 11.4 | 500 |
| Example 7 | 0 | 0.01 | 0.0002 | 0 | 9.4 | 400 |
| Example 8 | 0 | 0.01 | 0.0002 | 0 | 10.4 | 460 |
| Example 9 | 0 | 0.02 | 0.0002 | 0 | 10.4 | 460 |
| Example 10 | 0 | 0 | 0.0002 | 0 | 8.3 | 368 |
| Example 11 | 0 | 0.01 | 0 | 0.002 | 5.2 | 230 |
| Example 12 | 0 | 0.01 | 0 | 0.002 | 9.4 | 400 |
| Example 13 | 0 | 0.01 | 0 | 0.002 | 9.4 | 400 |
| Example 14 | 0 | 0.01 | 0 | 0.002 | 15.6 | 690 |
| Example 15 | 0 | 0.02 | 0 | 0.002 | 12.5 | 550 |
| Example 16 | 0 | 0.01 | 0 | 0.002 | 9.4 | 400 |
| Example 17 | 0 | 0.01 | 0.0002 | 0 | 9.4 | 400 |
| Example 18 | 0 | 0.01 | 0.0001 | 0 | 9.4 | 400 |
| Example 19 | 0 | 0 | 0.0002 | 0 | 5.4 | 240 |
| Example 20 | 0 | 0.01 | 0.0002 | 0 | 9.4 | 400 |
| Example 21 | 0 | 0.01 | 0.0002 | 0 | 9.4 | 400 |
| Example 22 | 5 | 0.01 | 0.0002 | 0 | 9.4 | 400 |
| Example 23 | 61 | 0.01 | 0.0002 | 0 | 9.4 | 400 |
| Comparative | 0 | 1.2 | 0 | 0 | 2 | 90 |
| Example 1 | | | | | | |
| Comparative | 0 | 4 | 0 | 0 | 0.2 | 11 |
| Example 2 | | | | | | |
| Comparative | 0 | 0.01 | 0 | 0 | 0.3 | 14 |
| Example 3 | | | | | | |
| Comparative | 0 | 0.15 | 0 | 0 | 1 | 45 |
| Example 4 | | | | | | |
| Comparative | 30 | 0.2 | 0 | 0 | 0.7 | 30 |
| Example 5 | | | | | | |
| Comparative | 0 | 0.01 | 0.0002 | 0 | 3 | 140 |
| Example 6 | | | | | | |

TABLE 3

| | Acetalization step | | | | | | | | | |
|---|---|---|---|---|---|---|---|---|---|---|
| | PVA | Water | Aldehyde | | PVB | Evaluation | | | | |
| | Parts by | Parts by | | Parts by | Mw | PVB resin sheet | | Interlayer film for laminated glass | | |
| | weight | weight | Type | weight | (×10⁴) | Strength | Rate | Transparency | Strength | Rate |
| Example 1 | 275 | 2890 | n-Butylaldehyde | 148 | 182 | 124 | ∘ | Good | 6.5 | ∘ |
| Example 2 | 314 | 2900 | n-Butylaldehyde | 172 | 257 | 147 | ∘ | Good | 7 | ∘ |
| Example 3 | 275 | 2890 | n-Butylaldehyde | 148 | 212 | 131 | ∘ | Good | 6.5 | ∘ |
| Example 4 | 275 | 2890 | n-Butylaldehyde | 148 | 390 | 168 | ∘ | Good | 7 | ∘ |
| Example 5 | 275 | 2890 | n-Butylaldehyde | 148 | 108 | 109 | ∘ | Good | 6 | ∘ |
| Example 6 | 275 | 2890 | n-Butylaldehyde | 148 | 199 | 127 | ∘ | Good | 6.5 | ∘ |
| Example 7 | 275 | 2890 | n-Butylaldehyde | 148 | 267 | 149 | ∘ | Good | 7 | ∘ |
| Example 8 | 275 | 2890 | n-Butylaldehyde | 148 | 205 | 126 | ∘ | Good | 6.5 | ∘ |
| Example 9 | 275 | 2890 | n-Butylaldehyde | 148 | 209 | 129 | ∘ | Good | 6.5 | ∘ |
| Example 10 | 275 | 2890 | n-Butylaldehyde | 148 | 210 | 131 | ∘ | Good | 6.5 | ∘ |
| Example 11 | 275 | 2890 | n-Butylaldehyde | 148 | 105 | 106 | ∘ | Slightly yellow | 6 | ∘ |
| Example 12 | 275 | 2890 | n-Butylaldehyde | 148 | 185 | 127 | ∘ | Good | 6.5 | ∘ |
| Example 13 | 275 | 2890 | n-Butylaldehyde | 148 | 184 | 124 | ∘ | Good | 6.5 | ∘ |
| Example 14 | 275 | 2890 | n-Butylaldehyde | 148 | 400 | 180 | ∘ | Good | 7 | ∘ |
| Example 15 | 275 | 2890 | n-Butylaldehyde | 148 | 420 | 181 | ∘ | Yellow | 7 | ∘ |
| Example 16 | 275 | 2890 | n-Butylaldehyde | 148 | 178 | 120 | ∘ | Slightly yellow | 6.5 | ∘ |
| Example 17 | 275 | 2890 | n-Butylaldehyde | 148 | 180 | 123 | ∘ | Good | 6.5 | ∘ |
| Example 18 | 275 | 2890 | n-Butylaldehyde | 148 | 180 | 123 | ∘ | Slightly cloudy | 6.5 | ∘ |
| Example 19 | 275 | 2890 | n-Butylaldehyde | 148 | 182 | 124 | ∘ | Good | 6.5 | ∘ |
| Example 20 | 275 | 2890 | n-Butylaldehyde | 148 | 183 | 124 | ∘ | Good | 6.5 | ∘ |
| Example 21 | 275 | 2890 | n-Butylaldehyde | 148 | 182 | 124 | ∘ | Good | 6.5 | ∘ |
| Example 22 | 275 | 2890 | n-Butylaldehyde | 148 | 98 | 101 | ∘ | Good | 6 | ∘ |
| Example 23 | 275 | 2890 | n-Butylaldehyde | 148 | 95 | 100 | ∘ | Good | 6 | ∘ |
| Comparative | 275 | 2890 | n-Butylaldehyde | 148 | 102 | 51 | x | Cloudy | 2.5 | x |
| Example 1 | | | | | | | | | | |
| Comparative | 314 | 2900 | n-Butylaldehyde | 172 | 16 | 38 | x | Cloudy | 2 | x |
| Example 2 | | | | | | | | | | |
| Comparative | 275 | 2890 | n-Butylaldehyde | 148 | 15 | 36 | x | Slightly yellow | 2 | x |
| Example 3 | | | | | | | | | | |
| Comparative | 275 | 2890 | n-Butylaldehyde | 148 | 31 | 44 | x | Cloudy | 2 | x |
| Example 4 | | | | | | | | | | |
| Comparative | 275 | 2890 | n-Butylaldehyde | 148 | 32 | 24 | x | Cloudy | 1 | x |
| Example 5 | | | | | | | | | | |
| Comparative | 275 | 2890 | n-Butylaldehyde | 148 | 84 | 96 | x | Good | 5 | x |
| Example 6 | | | | | | | | | | |

### INDUSTRIAL APPLICABILITY

The present invention can provide an ultra-high molecular weight polyvinyl alcohol resin that can provide, when acetalized, a resin film having high strength and high transparency. The present invention can also provide a polyvinyl acetal resin, a method for producing a polyvinyl alcohol resin, and a method for producing a polyvinyl acetal resin.

1. A polyvinyl alcohol resin comprising at least one selected from the group consisting of a sulfone group, an alkyl sulfonyl group, an aromatic sulfonyl group, a sulfine group, an imidazoline group, a carboxy group, an amide group, an amino group, and a hydroxy group at at least one molecular end of a main chain,
having a weight average molecular weight (Mw) of 1,000,000 or more, and
comprising a water-soluble surfactant in an amount of 0.02% by weight or less.

2. The polyvinyl alcohol resin according to claim 1, containing 0.0000001% by weight or more of a cationic surfactant.

3. The polyvinyl alcohol resin according to claim 1,
wherein a ratio (Mw/Mn) of the weight average molecular weight (Mw) to a number average molecular weight (Mn) is 1.0 to 3.0.

4. The polyvinyl alcohol resin according to claim 1,
wherein the polyvinyl alcohol resin has a degree of saponification of 70 mol % or higher and 99 mol % or lower.

5. The polyvinyl alcohol resin according to claim 1,
wherein the polyvinyl alcohol resin has a cloud point of 30° C. or higher.

6. The polyvinyl alcohol resin according to claim 1,
wherein the polyvinyl alcohol resin contains at least one selected from the group consisting of a dialkylamine compound containing a C1-C10 alkyl group and a trialkylamine compound containing a C1-C10 alkyl group.

7. A polyvinyl acetal resin, which is an acetalized product of the polyvinyl alcohol resin according to claim 1.

8. An interlayer film for a laminated glass, comprising the polyvinyl acetal resin according to claim 7.

9. A binder composition comprising the polyvinyl acetal resin according to claim 7.

10. A method for producing a polyvinyl alcohol resin, comprising:
a polymerization step of polymerizing a vinyl ester with addition of a polymerization initiator to produce a polyvinyl ester; and
a saponification step of saponifying the polyvinyl ester with addition of a saponification catalyst to produce a water-soluble polyvinyl alcohol resin,
wherein the polymerization initiator contains at least one selected from the group consisting of a sulfone group, an alkyl sulfonyl group, an aromatic sulfonyl group, a sulfine group, an imidazoline group, a carboxy group, an amide group, an amino group, and a hydroxy group.

11. The method for producing a polyvinyl alcohol resin according to claim 10,
wherein a water-soluble surfactant is added in the polymerization step in an amount of 0.02 parts by weight or less per 100 parts by weight of the vinyl ester.

12. The method for producing a polyvinyl alcohol resin according to claim 10,
wherein the polymerization step involves adding a polymerization initiator to an aqueous monomer solution containing a vinyl ester and water to produce an aqueous emulsion polymerization slurry containing a polyvinyl ester, where the polyvinyl ester in the aqueous emulsion polymerization slurry has an average particle size of 0.01 μm or more and 10 μm or less; and
the saponification step involves directly adding a saponification catalyst to the aqueous emulsion polymerization slurry to saponify the polyvinyl ester, where the saponification catalyst is at least one selected from the group consisting of a dialkylamine compound containing a C1-C10 alkyl group and a trialkylamine compound containing a C1-C10 alkyl group.

13. The method for producing a polyvinyl alcohol resin according to claim 10,
wherein the polymerization step involves adding a polymerization initiator to an aqueous monomer solution containing a vinyl ester and water to produce an aqueous emulsion polymerization slurry containing a polyvinyl ester, and further includes a recovery step of filtering a slurry prepared by adding a cationic surfactant to the aqueous emulsion polymerization slurry to recover the polyvinyl ester, and
the saponification step involves saponifying the polyvinyl ester recovered in the recovery step.

14. The method for producing a polyvinyl alcohol resin according to claim 10,
wherein a ratio (Mw/Mn) of a weight average molecular weight (Mw) to a number average molecular weight (Mn) of the polyvinyl ester is 1.0 to 3.0.

15. A method for producing a polyvinyl acetal resin, comprising
acetalizing the polyvinyl alcohol resin obtained by the method for producing a polyvinyl alcohol resin according to claim 10 with addition of an aldehyde.
